(19) United States
(12) Patent Application Publication
(10) Pub. No.: US 2022/0129820 A1
(43) Pub. Date: Apr. 28, 2022

(54) DATA STREAM NOISE IDENTIFICATION

(71) Applicant: Dell Products L.P., Round Rock, TX (US)

(72) Inventor: Piotr PRZESTRZELSKI, Rathcormac (IE)

(73) Assignee: Dell Products L.P., Round Rock, TX (US)

(21) Appl. No.: 17/078,426

(22) Filed: Oct. 23, 2020

(51) Int. Cl. G06Q 10/06; G06K 9/62

(52) U.S. Cl. CPC G06Q 10/06393; G06K 9/6222

(57) ABSTRACT

An information handling system may include at least one processor, and a non-transitory memory communicatively coupled to the at least one processor. The information handling system may be configured to: receive a data stream of data points indicative of a parameter of a monitored system; determine local maxima and minima based on the data stream; determine relative amplitudes of the local maxima and minima based on an absolute value of differences between consecutive ones of the local maxima and minima; partition the relative amplitudes into a plurality of clusters; and determine at least one of the plurality of clusters as at least one noise cluster.

### TECHNICAL FIELD

The present disclosure relates in general to information handling systems, and more particularly to systems and methods for data processing in information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

This disclosure relates generally to the area of data analysis. Embodiments may be applied to metric analysis of key performance indicators (KPIs), and, in particular, to numeric metric data stream online analysis. The numeric metric data stream is typically a list of numbers that describe certain parameter of a monitored system as these parameters change over time. For example, KPIs may include monitored telemetry values from a server information handling system.

A data stream is a list of values (e.g., representing a curve that is indicative of the behavior of the parameter over time). Meaningful events may be represented by features of the curve, but the curve may also contain data noise. Metric analysis generally looks for meaningful features of the curve, and it may be used to detect events represented by the features of the curve, detect anomalies, or make predictions on the data to come in the future. However, the noise is not typically of interest in metric analysis. Thus, the data noise needs to be distinguished from the useful features of the data stream. Embodiments of this disclosure may proceed by clustering the data into various clusters, one (or more) of which is designated a noise cluster.

Some existing methods attempt to use clustering techniques to detect noise in data. However, many drawbacks are present with existing techniques. For example, with the goal of noise detection, a clustering method capable of discovering clusters of different density has not heretofore been available. In particular, the noise cluster typically is quite dense (e.g., because noise fluctuations are relatively uniform). Elements of the noise cluster are represented by small numbers, and differences between these numbers are also small. Meanwhile, essential features are typically represented by large numbers, and differences between them are also bigger.

An objective of the disclosure is to provide a system and method to identify the noise in the data stream and be able to distinguish it from material features of the metric (e.g., the features that matter).

This type of task is simpler if the metric is periodic and the historical data is available: whatever repeats period after period is the material feature of the metric, and everything else is accidental (noise). With the noise characteristics discovered this way, noise may be distinguished from features in a data stream as it comes. However, when the metric is not periodic, or when historical data is not available, this approach is not feasible. This disclosure thus particularly targets the scenarios in which the metric is not periodic and/or the historical data is unavailable.

Some embodiments describe an unsupervised noise identification system for a numeric metric data stream that may be a burst of samples that is not periodic in nature, and wherein historical data cannot be used as a reference. The noise range identification may need to be done over a limited number of data stream samples at the beginning, so that it can be applied to the following upcoming samples.

The total burst of data samples is generally not periodic. It may be stochastic, or it may converge over time to some curve (for example, the metric analysis may need to discover the curve that is being converged upon by the metric), and at some point, the data stream ends.

Embodiments may involve a bespoke clustering method, such that based on the incoming samples, clusters are created, and one of the clusters is identified as the noise cluster.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with noise identification may be reduced or eliminated.

In accordance with embodiments of the present disclosure, an information handling system may include at least one processor, and a non-transitory memory communicatively coupled to the at least one processor. The information handling system may be configured to: receive a data stream of data points indicative of a parameter of a monitored system; determine local maxima and minima based on the data stream; determine relative amplitudes of the local maxima and minima based on an absolute value of differences between consecutive ones of the local maxima and minima; partition the relative amplitudes into a plurality of clusters; and determine at least one of the plurality of clusters as at least one noise cluster.

In accordance with these and other embodiments of the present disclosure, a method may include receiving, at an information handling system, a data stream of data points indicative of a parameter of a monitored system; the information handling system determining local maxima and minima based on the data stream; the information handling system determining relative amplitudes of the local maxima and minima based on an absolute value of differences between consecutive ones of the local maxima and minima; the information handling system partitioning the relative amplitudes into a plurality of clusters; and the information handling system determining at least one of the plurality of clusters as at least one noise cluster.

In accordance with these and other embodiments of the present disclosure, an article of manufacture may include a non-transitory, computer-readable medium having computer-executable instructions thereon that are executable by a processor of an information handling system for: receiving a data stream of data points indicative of a parameter of a monitored system; determining local maxima and minima based on the data stream; determining relative amplitudes of the local maxima and minima based on an absolute value of differences between consecutive ones of the local maxima and minima; partitioning the relative amplitudes into a plurality of clusters; and determining at least one of the plurality of clusters as at least one noise cluster.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example process flow, in accordance with embodiments of the present disclosure;

FIG. 3 illustrates an example process flow, in accordance with embodiments of the present disclosure;

FIG. 4 illustrates an example process flow, in accordance with embodiments of the present disclosure; and

FIG. 5 illustrates an example process flow, in accordance with embodiments of the present disclosure.

### DETAILED DESCRIPTION

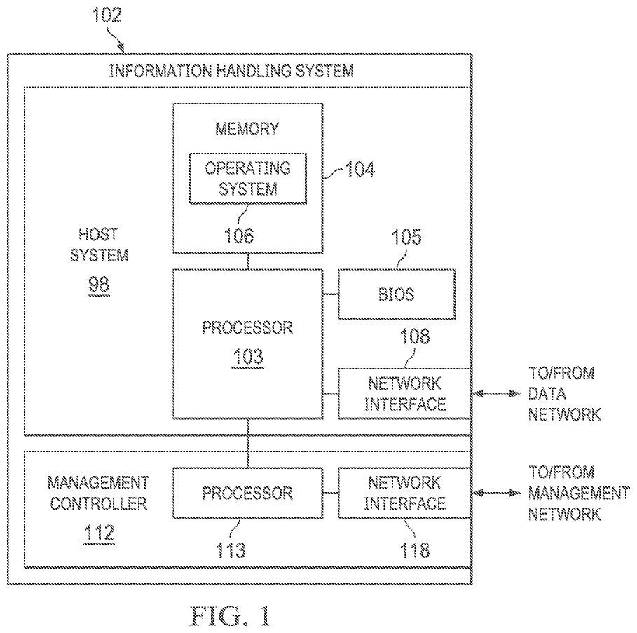

Preferred embodiments and their advantages are best understood by reference to FIGS. 1 through 5, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed in further detail below, embodiments of this disclosure may be used for data processing including noise identification in a data stream. An information handling system such as information handling system 102 may be used to implement some embodiments. In these and other embodiments, the data stream in question may be based on telemetry (e.g., physical sensor data, software metrics, etc.) collected from an information handling system such as information handling system 102.

In particular, noise in measurements of values (e.g., temperature, voltage, network latency, CPU utilization, memory utilization, etc.) may be analyzed to help discover whether the physical values detected conform to expected standards. For example, a thermometer in a physical device may receive some damage in transport and introduce noise to the temperature measurements. Embodiments may help discover if the noise exceeds the factory-expected levels. Otherwise, the damage might pass unnoticed for some time until a false alarm would be raised, and technical support called.

Noise identification in combination with filtering allows for simplification of the detection of metric features and makes the metric analysis more robust and reliable. Once a noise cluster has been identified, it may be reported to a user. In these and other embodiments, it may be filtered from the data to produce a more accurate representation of the underlying process.

Embodiments of this disclosure may use a clustering method to discover the noise level. The process of noise identification may include first performing data preparation, and then performing clustering analysis. As explained in further detail herein, once the clustering has been performed, a particular cluster may be identified as the noise cluster. For example, in one embodiment, the cluster with the most data points may be identified as the noise cluster, because noise may be relatively common in the data. Optionally, a cluster with the most data points and all clusters with smaller deviation than this cluster may be identified as the noise clusters.

According to one embodiment, at a high level, a noise identification process may include the following steps.

1. In some embodiments, an equalizing filter may be applied to data samples as they arrive by taking the mean of a number F of samples, replacing the central sample with that mean, and scaling the others samples accordingly. For example, for raw data samples (r₀, r₁, r₂, r₃, . . . ) filtered data samples (s₁, s₂, s₃, . . . ) may be determined as follows based upon a given F, which is referred to as the filter size. F may be an odd number in some embodiments to simplify the calculations, and in the following example F=3. The first filtered data sample may be determined as:

$${s}_{1} = \frac{{r}_{0} + {r}_{1} + {r}_{2}}{F}$$

In general, the filtered data samples may be determined as:

$${s}_{i } = {\sum }_{j = i - \frac{F - 1}{2}}^{j = i + \frac{F - 1}{2}} \frac{{r}_{j}}{F}$$

2. Local maxima and minima may be identified in the stream of filtered data samples. For example, taking i to be the sample number in the stream and s(i)=sᵢ to be the filtered sample value, then:

If s(i−1)<s(i) and s(i)>s(i+1), then s(i) is a local maximum.

If s(i−1)>s(i) and s(i)<s(i+1), then s(i) is a local minimum.

These local maxima and minima may then be recorded. The relative amplitude of the local maxima/minima may be calculated as an absolute value of the difference between the current maximum/minimum and the previous maximum/minimum, also referred to herein as a delta. This relative amplitude may then be used as an input into the bespoke clustering method—that is, clusters of the values of the deltas may be constructed.

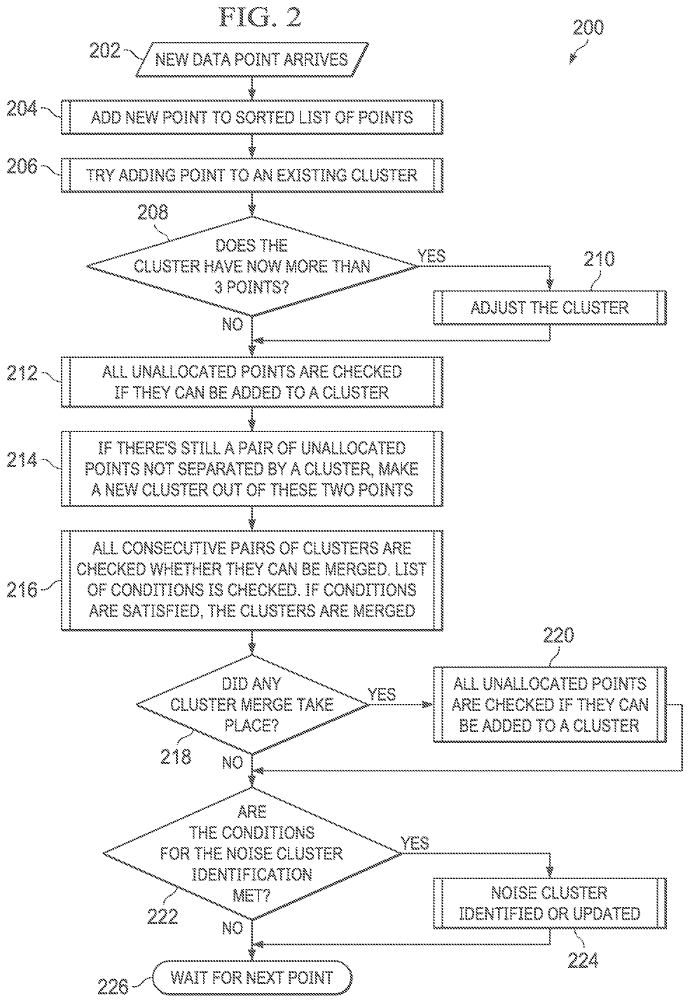

3. The clustering process itself may be carried out as described below and with reference to FIGS. 2 through 5, in some embodiments. Clusters may have the following properties:
Clusters are single-dimensional, in that a one-dimensional histogram of the deltas is examined.
Clusters do not overlap each other.
Clusters have a max point value (maxValue), a min point value (minValue), and a list of points in the cluster.
The size of a cluster is defined as the distance between the min point and the max point.
Max distance is the largest difference between consecutive points in the cluster.
Min distance is the smallest difference between consecutive points in the cluster.
The DiffSize is defined as the difference between the max distance and the min distance.

Turning now to FIG. 2, a flow chart is shown of an example method 200 for assignment of a data point to a cluster, in accordance with some embodiments of this disclosure. At step 202, a new data point (a point being, e.g., the value of relative amplitude of a local maximum or minimum of the filtered data stream) arrives.

At step 204, the new point is added to a sorted list (or other suitable data structure) of points. Since the burst of sample data is typically limited in size, the memory requirement for storing the points is typically not problematic.

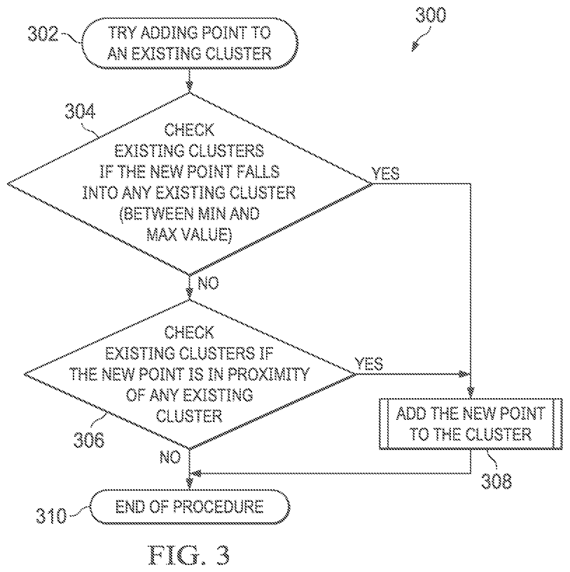

At step 206, an attempt may be made to add the point to an existing cluster. This step is described in more detail with respect to FIG. 3, which shows a flow chart of an example method 300 for adding a data point to an existing cluster, in accordance with some embodiments of this disclosure.

With momentary reference to FIG. 3, at step 302, an attempt is made to add the point to an existing cluster. In particular, at step 304, the existing clusters are checked to determine if the new point falls into any particular cluster (e.g., between the min point and the max point for that cluster). If so, the point is added to that cluster at step 308. If not, then at step 306 the existing clusters are checked to determine if the new point is in proximity to any particular cluster or clusters. If so, the point is added to the nearest cluster at step 308. If not, method 300 ends at step 310.

In some embodiments, the proximity of a point to a cluster (as discussed with regard to FIG. 3) may be defined as the union of two ranges: [minValue−Size*CIF, minVal)∪(maxValue, maxValue+Size*CIF], where CIF refers to a “cluster inclusion factor” that may be a global parameter such as a positive real number. For example, CIF may be equal to 0.01 in some embodiments.

In particular, a cluster may be understood as a space between the min value of a point that belongs to the cluster and the max value of a point that belongs to the cluster. Thus the cluster boundaries are defined by the lowest point (min value) and the highest point (max value). The size of the cluster is the distance from the lowest point to the highest point. The proximity of the cluster is then a margin extending downwards from the lowest point and upwards from the highest point. The size of the margin is a function of the size of the cluster: it is the cluster size multiplied by the CIF, which is a parameter of the system that can be configured by the user.

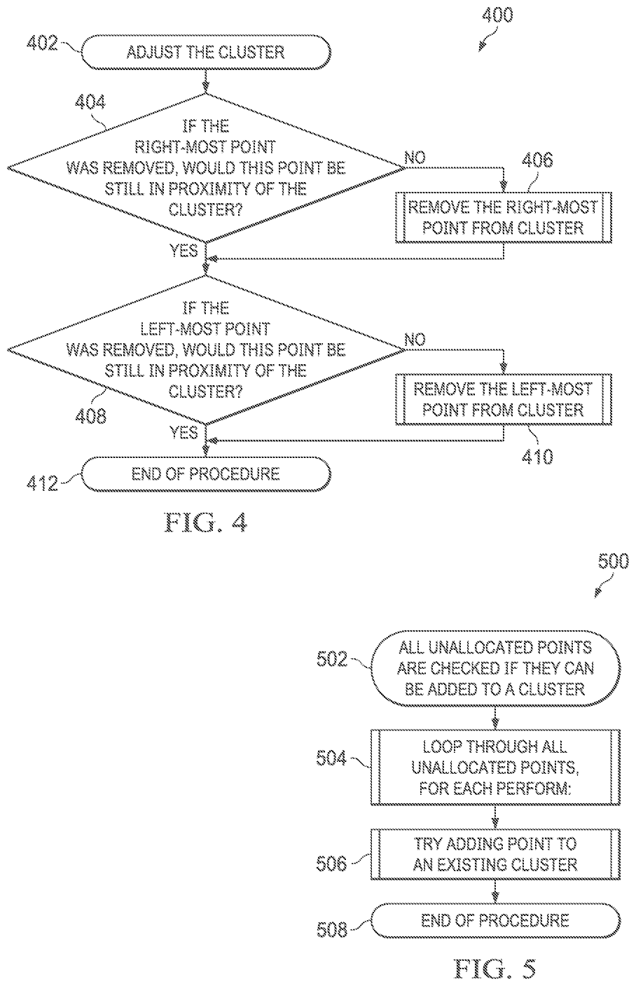

Returning now to FIG. 2, at step 208, if the new point was added to a cluster, it may be determined whether that cluster now has more than 3 points. If so, then the cluster may in some embodiments be adjusted at step 210. This step is described in more detail with respect to FIG. 4, which shows a flow chart of an example method 400 for cluster adjustment, in accordance with some embodiments of this disclosure.

With momentary reference to FIG. 4, at step 402, the decision to attempt to adjust the cluster is made. At step 404, a determination may be made regarding, if the right-most point were removed, would this point still be in proximity of the cluster (consisting of all of the other points in the cluster, including the new one)? If not, then the right-most point may be removed at step 406.

At step 408, a determination may be made regarding, if the left-most point were removed, would this point still be in proximity of the cluster (consisting of all of the other points in the cluster, including the new one)? If not, then the left-most point may be removed at step 410.

This procedure described in FIG. 4 thus allows removal of outliers from the cluster as the cluster grows.

Returning now to FIG. 2, at step 212 all unallocated points may be checked to see if they can be added to a cluster. This step is described in more detail with respect to FIG. 5, which shows a flow chart of an example method 500 for checking all unallocated points, in accordance with some embodiments of this disclosure.

With momentary reference to FIG. 5, at step 502, all unallocated points are checked to see if they can be added to a cluster, as per FIG. 3 discussed above.

In particular, at step 504, a loop may execute to check each unallocated point in turn, and for each such unallocated point, at step 506, an attempt is made to add it to an existing cluster, as per FIG. 3 discussed above.

Returning now to FIG. 2, at step 214, if a pair of unallocated points still exists that are not separated by a cluster, then a new cluster is created out of these two points.

At step 216, all consecutive pairs of clusters are checked to determine whether they can be merged. In some embodiments, the conditions for merging clusters may include the following:
a. Distance between these clusters is smaller than or equal to the size of any of these clusters.
b. Distances between consecutive points inside each of these clusters are in “similar ranges” (such that the density of the clusters is similar). The objective of this condition is to prevent merging of a small, dense cluster with a big, sparse cluster. For these purposes, the term “similar range” may be determined as follows.
Cluster 1 has:
   max distance (gap) between consecutive points=C1MaxDist
   min distance=C1MinDist
   difference between max and min distance C1DistDiff=C1MaxDist−C1MinDist
Similarly, Cluster 2 has C2MaxDist, C2MinDist and C2DistDiff=C2MaxDist−C2MinDist.

The “similar range” criterion may be considered true when the following condition is met:
C1MinDist−C1DistDiff*CDIF<=C2MinDist and C2MaxDist<=C1MaxDist+C1DiffDist*CDIF
Distances between consecutive points in cluster 2 are included in the extended range of distances in cluster 1. Or the opposite: distances between consecutive points in cluster 1 are included in the extended range of distances in cluster 2:
C2MinDist−C2DistDiff*CDIF<=C1MinDist and C1MaxDist<=C2MaxDist+C2DiffDist*CDIF
Where CDIF refers to a “cluster density inclusion factor” that may be a global parameter such as a positive real number. For example, CDIF may be equal to 0.01 in some embodiments.
If conditions (a) and (b) mentioned above are satisfied, then the clusters are merged.

At step 218, a determination may be made regarding whether or not any cluster merges took place in step 216. If so, then at step 220, another attempt to add any unallocated points may be performed, as per the discussion of FIG. 3 above.

At step 222, a check is performed whether conditions for the noise cluster identification are met. If not, the method may wait for the next point at step 226. If so, the method may identify or update the noise cluster at step 224.

One of ordinary skill in the art with the benefit of this disclosure will understand that the preferred initialization point for the methods depicted in FIGS. 2 through 5 and the order of the steps comprising those methods may depend on the implementation chosen. In these and other embodiments, this methods may be implemented as hardware, firmware, software, applications, functions, libraries, or other instructions. Further, although FIGS. 2 through 5 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

The conditions for the noise cluster identification of step 222 may be as follows in some embodiments:
a. There is more than 1 cluster.
b. One of the clusters has at least K times more points than any other cluster, where K is a real positive number greater than 1 and it is a global parameter. This condition is based on the assumption that noise fluctuations are more numerous than significant features of the metric data stream. If a cluster satisfies this condition, that cluster is now deemed to be the noise cluster.
c. Alternatively to (b), the absolute lowest cluster (such that its max point value is smaller than the min point of any other cluster) is deemed to be the noise cluster.

The discovered noise cluster has its characteristics like min and max point value, which can be interpreted as the level of noise (max as the upper level, or min and max as the lower and upper level).

With this assumption, the next incoming data are passed into the process, and if a new local minimum or maximum is detected and its relative amplitude falls into the noise cluster, then it is assumed to be noise and can be ignored.

It is also possible that with the new data coming in, the noise level may be updated, or even that the noise cluster may be changed to a different cluster.

The clustering techniques of this disclosure provide many benefits.

Generally speaking, the simplest approach to dealing with noise is to set some arbitrary level of noise. With that approach, a user assumes that everything lower than a given value is noise and can be disregarded. That allows the method to decide online (while the data samples are still coming) what is noise and what is not.

In an alternative approach, a user makes an assumption that the noise level is lower than a given percentage of the useful signal. In that case, the maximum of the useful signal needs to be known first, and so that approach can only be used as an offline method: first the maximum is discovered, and then the noise level is calculated.

Embodiments of this disclosure, in contrast, allows for the maximum noise level to be discovered online with clustering techniques, rather than setting some arbitrary cutoff value. No assumptions are needed regarding the level of noise, the levels of useful features of the metric curve, or the relation of the level of noise to the level of useful features. No assumptions are needed regarding historical or reference data. The clustering analyses according to this disclosure instead may take a “learn as you go” approach.

In particular, the clustering may be performed on the relative amplitudes of local maxima and minima (deltas), and the result is based on this data only. The bespoke clustering method also introduces a novel concept of cluster density as a condition for a pair of cluster merge.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a non-transitory memory communicatively coupled to the at least one processor;
wherein the information handling system is configured to:
receive a data stream of data points indicative of a parameter of a monitored system;
determine local maxima and minima based on the data stream;
determine relative amplitudes of the local maxima and minima based on an absolute value of differences between consecutive ones of the local maxima and minima;
partition the relative amplitudes into a plurality of clusters; and
determine at least one of the plurality of clusters as at least one noise cluster.

2. The information handling system of claim 1, further configured to apply an equalizing filter to the data stream prior to the determination of the local maxima and minima.

3. The information handling system of claim 1, wherein the at least one noise cluster is determined based on which of the plurality of clusters is largest.

4. The information handling system of claim 1, wherein the at least one noise cluster is determined based on which of the plurality of clusters represents a smallest deviation among its elements.

5. The information handling system of claim 1, further configured to perform cluster adjustment by removing at least one relative amplitude from a cluster.

6. The information handling system of claim 1, further configured to merge a first cluster and a second cluster together.

7. A method comprising:
receiving, at an information handling system, a data stream of data points indicative of a parameter of a monitored system;
the information handling system determining local maxima and minima based on the data stream;
the information handling system determining relative amplitudes of the local maxima and minima based on an absolute value of differences between consecutive ones of the local maxima and minima;
the information handling system partitioning the relative amplitudes into a plurality of clusters; and
the information handling system determining at least one of the plurality of clusters as at least one noise cluster.

8. The method of claim 7, further comprising applying an equalizing filter to the data stream prior to the determination of the local maxima and minima.

9. The method of claim 7, wherein the at least one noise cluster is determined based on which of the plurality of clusters is largest.

10. The method of claim 7, wherein the at least one noise cluster is determined based on which of the plurality of clusters represents a smallest deviation among its elements.

11. The method of claim 7, further comprising performing cluster adjustment by removing at least one relative amplitude from a cluster.

12. The method of claim 7, further comprising merging a first cluster and a second cluster together.

13. An article of manufacture comprising a non-transitory, computer-readable medium having computer-executable instructions thereon that are executable by a processor of an information handling system for:
receiving a data stream of data points indicative of a parameter of a monitored system;
determining local maxima and minima based on the data stream;
determining relative amplitudes of the local maxima and minima based on an absolute value of differences between consecutive ones of the local maxima and minima;
partitioning the relative amplitudes into a plurality of clusters; and
determining at least one of the plurality of clusters as at least one noise cluster.

14. The article of claim 13, wherein the instructions are further for applying an equalizing filter to the data stream prior to the determination of the local maxima and minima.

15. The article of claim 13, wherein the at least one noise cluster is determined based on which of the plurality of clusters is largest.

16. The article of claim 13, wherein the at least one noise cluster is determined based on which of the plurality of clusters represents a smallest deviation among its elements.

17. The article of claim 13, wherein the instructions are further for performing cluster adjustment by removing at least one relative amplitude from a cluster.

18. The article of claim 13, wherein the instructions are further for merging a first cluster and a second cluster together.
